(19) United States
(12) Patent Application Publication
(10) Pub. No.: US 2019/0377780 A1
(43) Pub. Date: Dec. 12, 2019

(54) AUTOMATED PATENT PREPARATION

(71) Applicant: Michael Carey, Boulder, CO (US)

(72) Inventor: Michael Carey, Boulder, CO (US)

(21) Appl. No.: 16/004,372

(22) Filed: Jun. 9, 2018

(51) Int. Cl. G06F 17/22; G06F 17/24; G06F 17/27; G06Q 10/10

(52) U.S. Cl. CPC G06F 17/2247; G06F 17/248; G06Q 50/184; G06F 17/2252; G06Q 10/10; G06F 17/2765

(57) ABSTRACT

Methods, systems, and devices for automated patent preparation are described. A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents.

### CROSS-REFERENCE TO RELATED APPLICATION

This application claims priority to, and the benefit of, U.S. Provisional Application Ser. No. 62/523,854 filed on Jun. 23, 2017, entitled AUTOMATED PATENT PREPARATION. The entire contents of the foregoing application are hereby incorporated by reference for all purposes.

### BACKGROUND

The following relates generally to automated patent preparation. Patent preparation is often performed by patent attorneys or agents who draft documents that are then submitted to the United States Patent and Trademark Office (USPTO). In some cases, the labor involved in preparing may involve the expenditure of a significant amount of time and may cost a significant amount of money. In some cases, the costs associated with patent preparation may inhibit inventors from patenting and benefitting from useful inventions.

### SUMMARY

A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents. An automated patent preparation system may therefore be used to reduce the time and cost associated with patent preparation.

In one embodiment, a method may include identifying a patent specification template, identifying an application data object associated with a patent disclosure, generating specification data based on the application data object, and generating a patent specification document based on the patent specification template and the specification data.

In one embodiment, a non-transitory computer-readable medium may include instructions operable to cause a processor to identify a patent specification template, identify an application data object associated with a patent disclosure, generate specification data based on the application data object, and generate a patent specification document based on the patent specification template and the specification data.

In one embodiment, an apparatus may include a processor, memory in electronic communication with the processor, and instructions stored in the memory. The instructions may be operable to cause the processor to identify a patent specification template, identify an application data object associated with a patent disclosure, generate specification data based on the application data object, and generate a patent specification document based on the patent specification template and the specification data.

In one embodiment, an apparatus may include means for identifying a patent specification template, means for identifying an application data object associated with a patent disclosure, means for generating specification data based on the application data object, and means for generating a patent specification document based on the patent specification template and the specification data.

In some examples of the method, non-transitory computer-readable medium, and apparatus described above, the specification data comprises claim data, summary data, background data, brief description data, detailed description data, or any combination thereof. In some examples of the method, non-transitory computer-readable medium, and apparatus described above, the patent specification template comprises a first set of extensible markup language (XML) parts, and the specification data comprises a second set of XML parts.

Some examples of the method, non-transitory computer-readable medium, and apparatus described above may further include processes, features, means, or instructions for decompressing the patent specification template to obtain the first set of XML parts. Some examples of the method, non-transitory computer-readable medium, and apparatus described above may further include processes, features, means, or instructions for combining the first set of XML parts and the second set of XML parts. Some examples of the method, non-transitory computer-readable medium, and apparatus described above may further include processes, features, means, or instructions for compressing the combination of the first set of XML parts and the second set of XML parts, wherein the patent specification document may be generated based on the compressed combination.

In some examples of the method, non-transitory computer-readable medium, and apparatus described above, the specification data comprises a list of replace objects comprising a marker and an associated XML part from the second set of XML parts, wherein combining the first set of XML parts and the second set of XML parts comprises: finding text matching the marker for one or more of the replace objects within the first set of XML parts and replacing the text with the associated XML part for the marker.

In some examples of the method, non-transitory computer-readable medium, and apparatus described above, the specification data comprises a list of insertion objects comprising a marker and an associated XML part from the second set of XML parts, wherein combining the first set of XML parts and the second set of XML parts comprises: finding a location for the marker for one or more of the replace objects within the first set of XML parts and inserting the associated XML part for the marker at the location.

In some examples of the method, non-transitory computer-readable medium, and apparatus described above, the patent specification document may be generated using a VB document processing library, a.NET document processing library, or a combination thereof. In some examples of the method, non-transitory computer-readable medium, and apparatus described above, the specification data may be generated based on code written in a computer programming language. In some examples of the method, non-transitory computer-readable medium, and apparatus described above, the application data object comprises an XML object, a JavaScript object notation (JSON) object, a formatted data object, a data string, or a combination thereof.

Some examples of the method, non-transitory computer-readable medium, and apparatus described above may further include processes, features, means, or instructions for identifying a patent drawing template. Some examples of the method, non-transitory computer-readable medium, and apparatus described above may further include processes, features, means, or instructions for generating drawing data based on the application data object. Some examples of the method, non-transitory computer-readable medium, and apparatus described above may further include processes, features, means, or instructions for generating a patent drawing document based on the patent drawing template and the drawing data. In some examples of the method, non-transitory computer-readable medium, and apparatus described above, the patent drawing template comprises a first set of XML parts, and the drawing data comprises a second set of XML parts.

Some examples of the method, non-transitory computer-readable medium, and apparatus described above may further include processes, features, means, or instructions for decompressing the patent drawing template to obtain the first set of XML parts. Some examples of the method, non-transitory computer-readable medium, and apparatus described above may further include processes, features, means, or instructions for combining the first set of XML parts and the second set of XML parts. Some examples of the method, non-transitory computer-readable medium, and apparatus described above may further include processes, features, means, or instructions for compressing the combination of the first set of XML parts and the second set of XML parts, wherein the patent drawing document may be generated based on the compressed combination.

Some examples of the method, non-transitory computer-readable medium, and apparatus described above may further include processes, features, means, or instructions for identifying one or more figure objects from the application data object. Some examples of the method, non-transitory computer-readable medium, and apparatus described above may further include processes, features, means, or instructions for generating a page XML part for each of the one or more figure objects, wherein the second set of XML parts comprises the page XML part.

In some examples of the method, non-transitory computer-readable medium, and apparatus described above, the application data object comprises application information, a plurality of application features, one or more figure objects, one or more acronym definitions, or any combination thereof. In some examples of the method, non-transitory computer-readable medium, and apparatus described above, the application information includes an application identifier, a title, an inventor, a template identifier, an assignee, or any combination thereof. In some examples of the method, non-transitory computer-readable medium, and apparatus described above, the patent specification template may be identified based on the template identifier.

In some examples of the method, non-transitory computer-readable medium, and apparatus described above, the plurality of application features comprise claim features, background features, embodiment features, or any combination thereof. In some examples of the method, non-transitory computer-readable medium, and apparatus described above, each of the plurality of application features may be associated with a system component. In some examples of the method, non-transitory computer-readable medium, and apparatus described above, the one or more figure objects comprise one or more flowchart objects, one or more diagram objects, or both.

In some examples of the method, non-transitory computer-readable medium, and apparatus described above, the one or more flowchart objects comprise one or more step objects, wherein each of the one or more step objects comprises a text value and a component association. In some examples of the method, non-transitory computer-readable medium, and apparatus described above, the one or more diagram objects comprise one or more component objects, wherein each of the one or more component objects comprises a component name and or more features.

Some examples of the method, non-transitory computer-readable medium, and apparatus described above may further include processes, features, means, or instructions for replacing one or more acronyms in the patent specification document based on the one or more acronym definitions. Some examples of the method, non-transitory computer-readable medium, and apparatus described above may further include processes, features, means, or instructions for generating the application data object based on input from a user interface.

Some examples of the method, non-transitory computer-readable medium, and apparatus described above may further include processes, features, means, or instructions for storing the application data object in a database. Some examples of the method, non-transitory computer-readable medium, and apparatus described above may further include processes, features, means, or instructions for retrieving the application data object from the database. Some examples of the method, non-transitory computer-readable medium, and apparatus described above may further include processes, features, means, or instructions for updating the application data object based on additional input, wherein the specification data may be based on the updated application data object.

Some examples of the method, non-transitory computer-readable medium, and apparatus described above may further include processes, features, means, or instructions for associating each of a plurality of features with a system component at the user interface, wherein the application data object may be based on the association. Some examples of the method, non-transitory computer-readable medium, and apparatus described above may further include processes, features, means, or instructions for transmitting code for a user interface to a user terminal, wherein the input may be generated at the user terminal.

In some examples of the method, non-transitory computer-readable medium, and apparatus described above, the user interface comprises a website. In some examples of the method, non-transitory computer-readable medium, and apparatus described above, the user interface comprises a plurality of tabs including a feature tab, a figure tab, an application data tab, an acronym tab, or any combination thereof.

### BRIEF DESCRIPTION OF THE DRAWINGS

FIG. 1 shows a block diagram that supports automated patent preparation in accordance with aspects of the present disclosure.

FIGS. 2 through 7 show flowcharts that support automated patent preparation in accordance with aspects of the present disclosure.

### DETAILED DESCRIPTION

Methods, systems, and devices for automated patent preparation are described. A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents.

By receiving input in the form of an application data object and generating a specification data object (and, in some cases, a drawings data object), the system may store patent application information more efficiently (e.g., only a limited set of application inputs may be stored as opposed to a document that includes template information, boilerplate, and many repetitions of the same data) and avoid unnecessary repetition of certain patent drafting tasks. For example, the application data object may include an association of each claim element to a system component. A lookup function may then associate the system component with each of the associated. Thus, when generating a description of each figure that contains that component, an automated function can be applied to a list of features or elements associated with the component, thereby automatically providing structural support for a method claim, and support in the specification for claim elements.

Similarly, flowcharts may be automatically generated from claims and, since the claim elements have component associations, language may be automatically generated that states which system components perform each step of a flowchart, and automatically generate connecting language associating steps of a flowchart to descriptions of a diagram representing an apparatus including the relevant system components.

Also, figure numbering and written description numbering may be made consistent in an automated way by generating a list of components for each figure, assigning each component in the list a number (e.g., with a systematic algorithm such as adding 5 or 10 to the last component number) and doing a replace function on mentions of that component in a figure description. In some cases, automatic numbering insertion may utilize dynamic references instead of static numbers so that if figures or components are added in a word processing application such as Microsoft Word, the numbers are encoded with information that allows the word processing application to automatically renumber the figure components (i.e., using bookmarks and reference fields in the numbering elements that are inserted by the find and replace function).

In some examples, the system may utilize exceptions to prevent insertion of component numbers in undesired locations. For example, if one component is called component A and a second component is called component AB, the first component would be a substring of the second component, Thus, the system may create an exception such that it does not replace the string ‘component A’ in the with the component number for component A in the string component AB. In one embodiment this may be done using regular expressions to search for component names but exclude other ‘including’ component names.

In some cases, the system generates one extensible markup language (XML) objects corresponding to text or fields to be inserted into a template. The system may then decompress a template, identify the document XML, and insert the generated XML components into the document XML. The document XML may then be recompressed along with other files associated with the document to create a draft specification (or, as the case may be, the drawings). This may enable separate template and boilerplate information to be stored separately from the application inputs, and may facilitate an automated process for generating patent document content and combining the generated application specific content with content from a template or library.

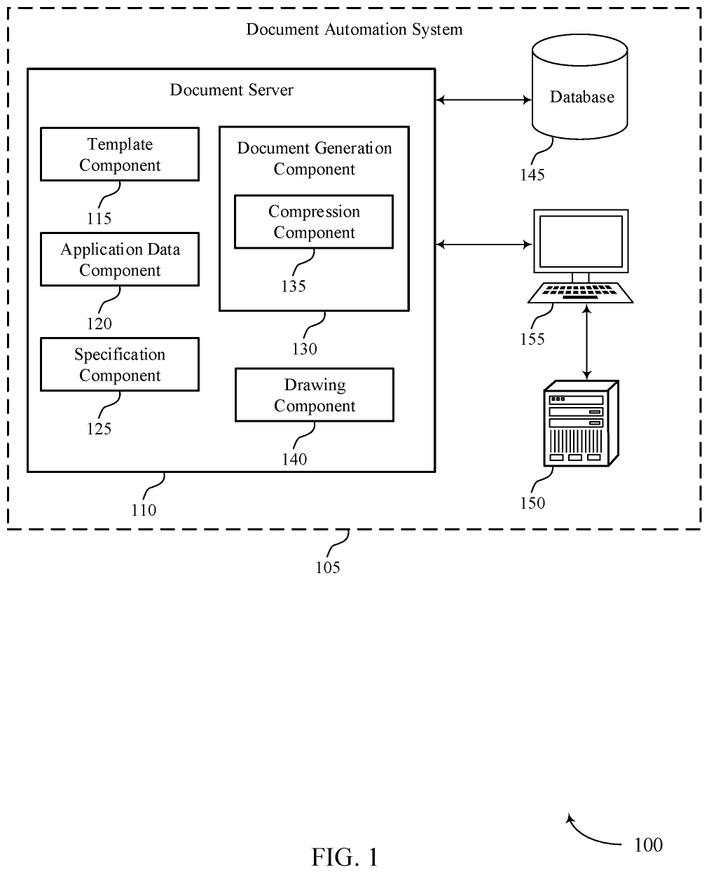

FIG. 1 shows a block diagram 100 that supports automated patent preparation in accordance with aspects of the present disclosure. Block diagram 100 may include an illustration of document automation system 105.

In some examples, document automation system 105 may include at least one of the following components: document server 110, database 145, web server 150, and user interface 155. In some examples, document server 110 may include at least one of the following components: template component 115, application data component 120, specification component 125, document generation component 130, and drawing component 140. Document server 110 may also include a processor, memory, and software (not shown).

The processor may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor may be configured to operate a memory array using a memory controller. In other cases, a memory controller may be integrated into processor. Processor may be configured to execute computer-readable instructions stored in a memory to perform various functions (e.g., functions or tasks supporting automated patent preparation).

The memory document server 110 may include RAM, ROM, and other forms of memory. The memory may store computer-readable, computer-executable software including instructions that, when executed, cause the processor to perform various functions described herein. In some cases, the memory may contain, among other things, a BIOS which may control basic hardware or software operation such as the interaction with peripheral components or devices.

The software of document server 110 may include code to implement aspects of the present disclosure, including code to support automated patent preparation. Software may be stored in a non-transitory computer-readable medium such as system memory or other memory. In some cases, the software may not be directly executable by the processor but may cause a computer (e.g., when compiled and executed) to perform functions described herein.

Template component 115 may be configured to identify a patent specification template and identify a patent drawing template.

Application data component 120 may be configured to identify an application data object associated with a patent disclosure; identify one or more figure objects from the application data object; and generate the application data object based on input from a user interface 155.

In some cases, the application data object comprises an extensible markup language (XML) object, a JavaScript object notation (JSON) object, a formatted data object, a data string, or a combination thereof. In some cases, the application data object comprises application information, a plurality of application features, one or more figure objects, one or more acronym definitions, or any combination thereof. In some cases, the application information includes an application identifier, a title, an inventor, a template identifier, an assignee, or any combination thereof. In some cases, the patent specification template is identified based on the template identifier.

In some cases, the plurality of application features comprise claim features, background features, embodiment features, or any combination thereof. In some cases, each of the plurality of application features is associated with a system component. In some cases, the one or more figure objects comprise one or more flowchart objects, one or more diagram objects, or both. In some cases, the one or more flowchart objects comprise one or more step objects, wherein each of the one or more step objects comprises a text value and a component association. In some cases, the one or more diagram objects comprise one or more component objects, wherein each of the one or more component objects comprises a component name and or more features.

Specification component 125 may be configured to generate specification data based on the application data object. In some cases, the specification data comprises claim data, summary data, background data, brief description data, detailed description data, or any combination thereof. In some cases, the patent specification template comprises a first set of XML parts, and the specification data comprises a second set of XML parts. In some cases, the specification data comprises a list of replace objects comprising a marker and an associated XML part from the second set of XML parts, wherein combining the first set of XML parts and the second set of XML parts comprises: finding text matching the marker for one or more of the replace objects within the first set of XML parts and replacing the text with the associated XML part for the marker.

In some cases, the specification data comprises a list of insertion objects comprising a marker and an associated XML part from the second set of XML parts, wherein combining the first set of XML parts and the second set of XML parts comprises: finding a location for the marker for one or more of the replace objects within the first set of XML parts and inserting the associated XML part for the marker at the location. In some cases, the specification data is generated based on code written in a computer programming language.

Document generation component 130 may be configured to generate a patent specification document based on the patent specification template and the specification data; combine the first set of XML parts and the second set of XML parts; generate a patent drawing document based on the patent drawing template and the drawing data; and replace one or more acronyms in the patent specification document based on the one or more acronym definitions. In some examples, document generation component 130 may include at least one compression component 135. In some cases, the patent specification document is generated using a VB document processing library, a.NET document processing library, or a combination thereof.

Compression component 135 may be configured to decompress the patent specification template to obtain the first set of XML parts; compress the combination of the first set of XML parts and the second set of XML parts, wherein the patent specification document is generated based on the compressed combination; decompress the patent drawing template to obtain the first set of XML parts; and compress the combination of the first set of XML parts and the second set of XML parts, wherein the patent drawing document is generated based on the compressed combination.

Drawing component 140 may be configured to generate drawing data based on the application data object and generate a page XML part for each of the one or more figure objects, wherein the second set of XML parts comprises the page XML part. In some cases, the patent drawing template comprises a first set of XML parts, and the drawing data comprises a second set of XML parts.

Database 145 may be configured to database 145 may be a single database 145, a distributed database 145, multiple distributed databases 145, or an emergency backup database 145 and store the application data object in a database 145. In some cases, the database 145 may be a graph database, or a relational database such as a SQL database, or a No-SQL database such as a MongoDB database.

Web server 150 may be configured to transmit code for a user interface 155 to a user terminal, wherein the input is generated at the user terminal.

User interface 155 may enable a user to interact with document automation system 105; retrieve the application data object from the database 145; update the application data object based on additional input, wherein the specification data is based on the updated application data object; and associate each of a plurality of features with a system component, wherein the application data object is based on the association. In some embodiments, the user interface 155 module may include an audio device, such as an external speaker system, an external display device such as a display screen, or an input device (e.g., remote control device interfaced with the user interface 155 module directly or through an IO controller module).

An IO controller (not shown) may manage input and output signals for a terminal operating the user interface. The IO controller may also manage peripherals not integrated into a device. In some cases, the IO controller may represent a physical connection or port to an external peripheral. In some cases, the IO controller may utilize an operating system such as iOS®, ANDROID®, MS-DOS®, MS-WINDOWS®, OS/2®, UNIX®, LINUX®, or another known operating system. In other cases, the IO controller may represent or interact with a modem, a keyboard, a mouse, a touchscreen, or a similar device. In some cases, the IO controller may be implemented as part of a processor. In some cases, a user may interact with a device via the IO controller or via hardware components controlled by the IO controller

In some cases, the user interface 155 comprises a website. In some cases, the user interface 155 comprises a plurality of tabs including a feature tab, a figure tab, an application data tab, an acronym tab, or any combination thereof.

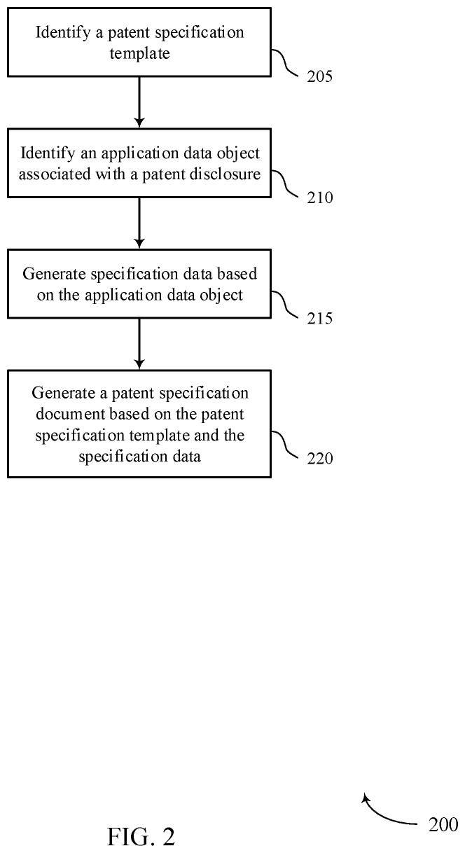

FIG. 2 shows a flowchart 200 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 205 the system or apparatus may identify a patent specification template. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 210 the system or apparatus may identify an application data object associated with a patent disclosure. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 215 the system or apparatus may generate specification data based on the application data object. The operations of this block may be performed according to the methods and processes described in the present disclosure. For example, the operations of this block may be composed of various substeps, or may be performed in conjunction with other operations described herein. In certain examples, aspects of the described operations may be performed by a specification component as described with reference to FIG. 1.

At block 220 the system or apparatus may generate a patent specification document based on the patent specification template and the specification data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

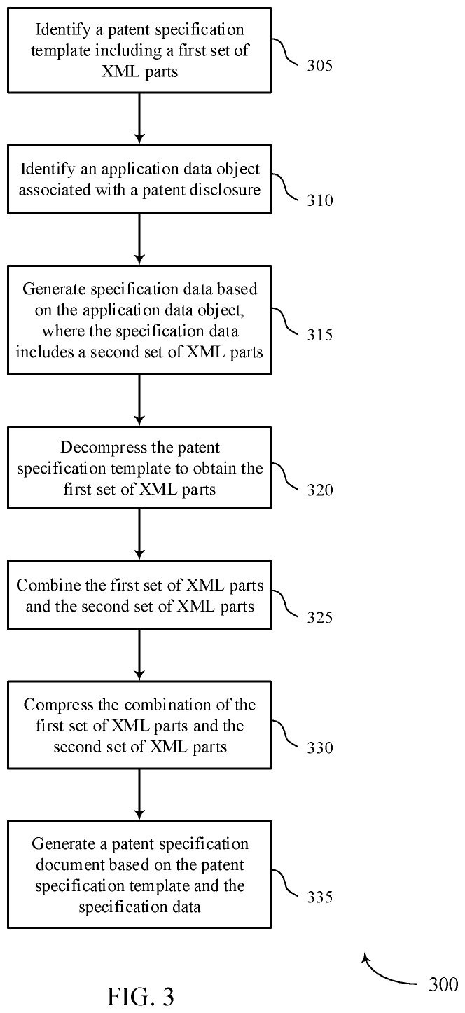

FIG. 3 shows a flowchart 300 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 305 the system or apparatus may identify a patent specification template including a first set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 310 the system or apparatus may identify an application data object associated with a patent disclosure. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 315 the system or apparatus may generate specification data based on the application data object, wherein the specification data includes a second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a specification component as described with reference to FIG. 1.

At block 320 the system or apparatus may decompress the patent specification template to obtain the first set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a compression component as described with reference to FIG. 1.

At block 325 the system or apparatus may combine the first set of XML parts and the second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

At block 330 the system or apparatus may compress the combination of the first set of XML parts and the second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a compression component as described with reference to FIG. 1.

At block 335 the system or apparatus may generate a patent specification document based on the patent specification template and the specification data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

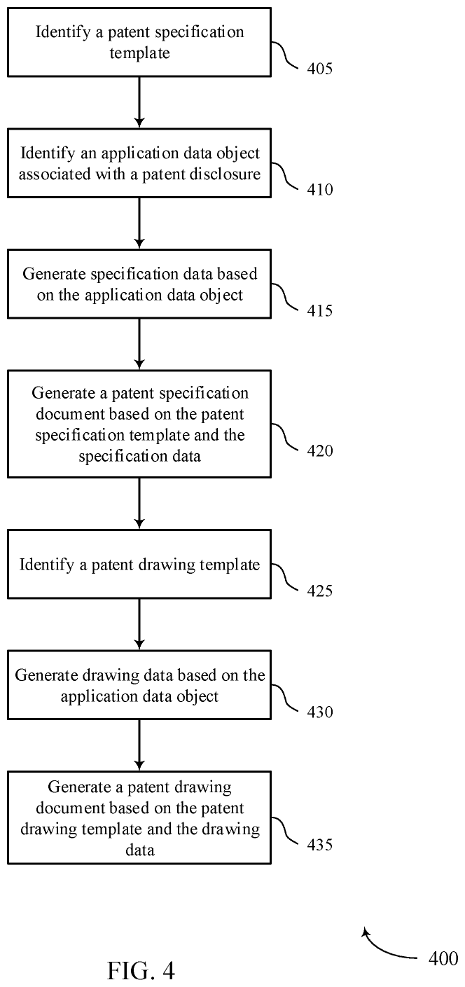

FIG. 4 shows a flowchart 400 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 405 the system or apparatus may identify a patent specification template. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 410 the system or apparatus may identify an application data object associated with a patent disclosure. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 415 the system or apparatus may generate specification data based on the application data object. The operations of this block may be performed according to the methods and processes described in the present disclosure. For example, the operations of this block may be composed of various substeps, or may be performed in conjunction with other operations described herein. In certain examples, aspects of the described operations may be performed by a specification component as described with reference to FIG. 1.

At block 420 the system or apparatus may generate a patent specification document based on the patent specification template and the specification data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

At block 425 the system or apparatus may identify a patent drawing template. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 430 the system or apparatus may generate drawing data based on the application data object. The operations of this block may be performed according to the methods and processes described in the present disclosure. For example, the operations of this block may be composed of various substeps, or may be performed in conjunction with other operations described herein. In certain examples, aspects of the described operations may be performed by a drawing component as described with reference to FIG. 1.

At block 435 the system or apparatus may generate a patent drawing document based on the patent drawing template and the drawing data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

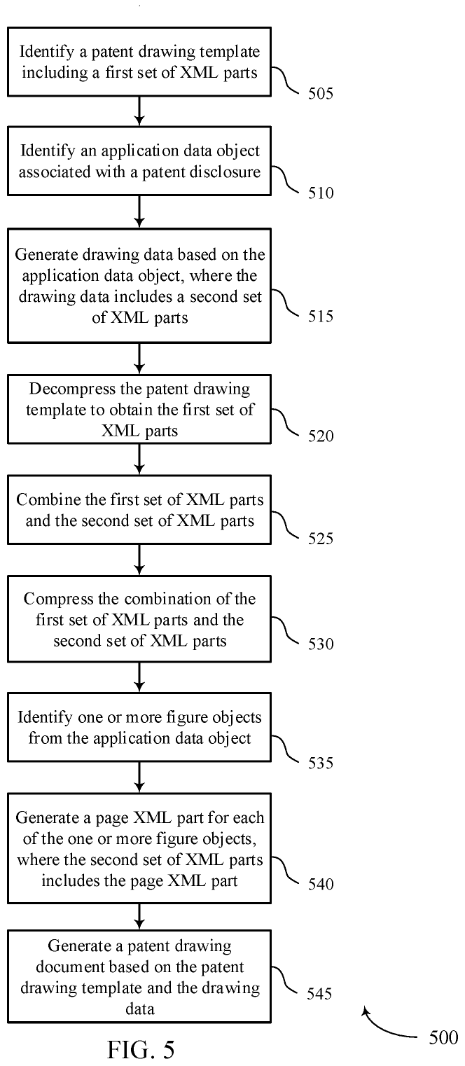

FIG. 5 shows a flowchart 500 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 505 the system or apparatus may identify a patent drawing template including a first set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 510 the system or apparatus may identify an application data object associated with a patent disclosure. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 515 the system or apparatus may generate drawing data based on the application data object, wherein the drawing data includes a second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a drawing component as described with reference to FIG. 1.

At block 520 the system or apparatus may decompress the patent drawing template to obtain the first set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a compression component as described with reference to FIG. 1.

At block 525 the system or apparatus may combine the first set of XML parts and the second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

At block 530 the system or apparatus may compress the combination of the first set of XML parts and the second set of XML parts. The operations of this block may be performed according to the methods and processes described in the present disclosure. For example, the operations of this block may be composed of various substeps, or may be performed in conjunction with other operations described herein. In certain examples, aspects of the described operations may be performed by a compression component as described with reference to FIG. 1.

At block 535 the system or apparatus may identify one or more figure objects from the application data object. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 540 the system or apparatus may generate a page XML part for each of the one or more figure objects, wherein the second set of XML parts comprises the page XML part. The operations of this block may be performed according to the methods and processes described in the present disclosure. For example, the operations of this block may be composed of various substeps, or may be performed in conjunction with other operations described herein. In certain examples, aspects of the described operations may be performed by a drawing component as described with reference to FIG. 1.

At block 545 the system or apparatus may generate a patent drawing document based on the patent drawing template and the drawing data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

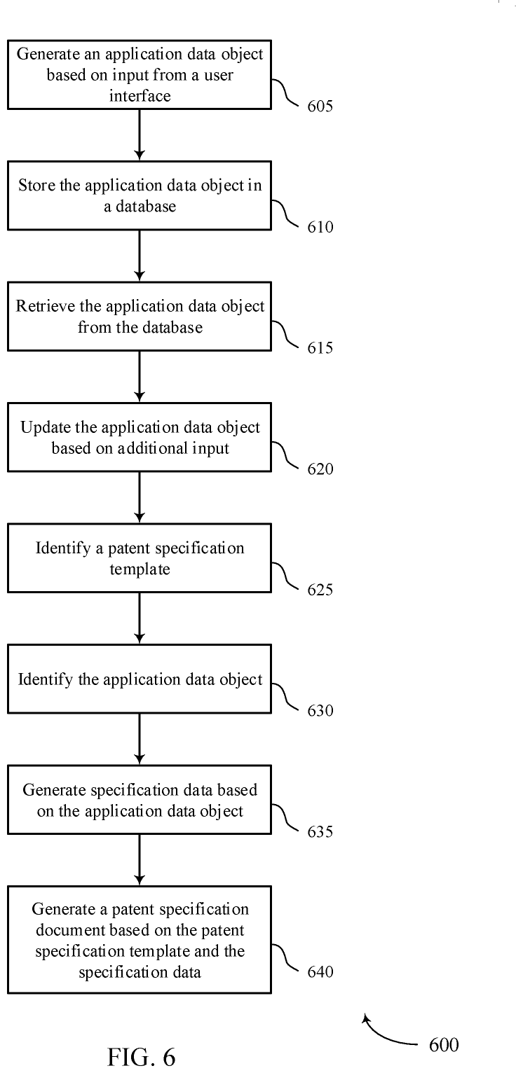

FIG. 6 shows a flowchart 600 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 605 the system or apparatus may generate an application data object based on input from a user interface. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 610 the system or apparatus may store the application data object in a database. The operations of this block may be performed according to the methods and processes described in the present disclosure. For example, the operations of this block may be composed of various substeps, or may be performed in conjunction with other operations described herein. In certain examples, aspects of the described operations may be performed by a database as described with reference to FIG. 1.

At block 615 the system or apparatus may retrieve the application data object from the database. The operations of this block may be performed according to the methods and processes described in the present disclosure. For example, the operations of this block may be composed of various substeps, or may be performed in conjunction with other operations described herein. In certain examples, aspects of the described operations may be performed by a user interface as described with reference to FIG. 1.

At block 620 the system or apparatus may update the application data object based on additional input. The operations of this block may be performed according to the methods and processes described in the present disclosure. For example, the operations of this block may be composed of various substeps, or may be performed in conjunction with other operations described herein. In certain examples, aspects of the described operations may be performed by a user interface as described with reference to FIG. 1.

At block 625 the system or apparatus may identify a patent specification template. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 630 the system or apparatus may identify the application data object. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 635 the system or apparatus may generate specification data based on the application data object. The operations of this block may be performed according to the methods and processes described in the present disclosure. For example, the operations of this block may be composed of various substeps, or may be performed in conjunction with other operations described herein. In certain examples, aspects of the described operations may be performed by a specification component as described with reference to FIG. 1.

At block 640 the system or apparatus may generate a patent specification document based on the patent specification template and the specification data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

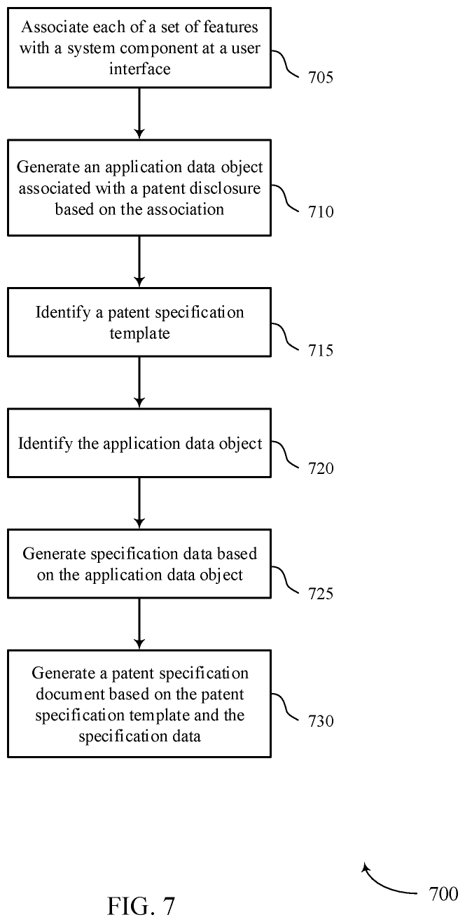

FIG. 7 shows a flowchart 700 that supports automated patent preparation in accordance with aspects of the present disclosure. In some examples, a system or apparatus may execute a set of codes to control the functional elements of a document automation system to perform the described functions. Additionally or alternatively, the system or apparatus may perform aspects of the functions described below using special-purpose hardware.

At block 705 the system or apparatus may associate each of a plurality of features with a system component at a user interface. The operations of this block may be performed according to the methods and processes described in the present disclosure. For example, the operations of this block may be composed of various substeps, or may be performed in conjunction with other operations described herein. In certain examples, aspects of the described operations may be performed by a user interface as described with reference to FIG. 1.

At block 710 the system or apparatus may generate an application data object associated with a patent disclosure based on the association. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 715 the system or apparatus may identify a patent specification template. The operations of this block may be performed according to the methods and processes described in the present disclosure. For example, the operations of this block may be composed of various substeps, or may be performed in conjunction with other operations described herein. In certain examples, aspects of the described operations may be performed by a template component as described with reference to FIG. 1.

At block 720 the system or apparatus may identify the application data object. The operations of this block may be performed according to the methods and processes described in the present disclosure. For example, the operations of this block may be composed of various substeps, or may be performed in conjunction with other operations described herein. In certain examples, aspects of the described operations may be performed by an application data component as described with reference to FIG. 1.

At block 725 the system or apparatus may generate specification data based on the application data object. The operations of this block may be performed according to the methods and processes described in the present disclosure. For example, the operations of this block may be composed of various substeps, or may be performed in conjunction with other operations described herein. In certain examples, aspects of the described operations may be performed by a specification component as described with reference to FIG. 1.

At block 730 the system or apparatus may generate a patent specification document based on the patent specification template and the specification data. The operations of this block may be performed according to the methods and processes described in the present disclosure. For example, the operations of this block may be composed of various substeps, or may be performed in conjunction with other operations described herein. In certain examples, aspects of the described operations may be performed by a document generation component as described with reference to FIG. 1.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a DSP, an ASIC, an FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read only memory (EEPROM), compact disk (CD) ROM or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, digital subscriber line (DSL), or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for automated patent preparation, comprising:
identifying a patent specification template;
identifying an application data object associated with a patent disclosure, wherein the application data object comprises a plurality of application features and a plurality of system components;
generating specification data based on the application data object; and
generating a patent specification document based on the patent specification template and the specification data.

2. The method of claim 1, wherein:
the patent specification template comprises a first set of extensible markup language (XML) parts, and the specification data comprises a second set of XML parts.

3. The method of claim 2, further comprising:
decompressing the patent specification template to obtain the first set of XML parts;
combining the first set of XML parts and the second set of XML parts; and
compressing the combination of the first set of XML parts and the second set of XML parts, wherein the patent specification document is generated based on the compressed combination.

4. The method of claim 3, wherein:
the specification data comprises a list of replace objects comprising a marker and an associated XML part from the second set of XML parts, wherein combining the first set of XML parts and the second set of XML parts comprises: finding text matching the marker for one or more of the replace objects within the first set of XML parts and replacing the text with the associated XML part for the marker.

5. The method of claim 3, wherein:
the specification data comprises a list of insertion objects comprising a marker and an associated XML part from the second set of XML parts, wherein combining the first set of XML parts and the second set of XML parts comprises: finding a location for the marker for one or more of the replace objects within the first set of XML parts and inserting the associated XML part for the marker at the location.

6. The method of claim 1, further comprising:
identifying a patent drawing template;
generating drawing data based on the application data object; and
generating a patent drawing document based on the patent drawing template and the drawing data.

7. The method of claim 6, wherein:
the patent drawing template comprises a first set of XML parts, and the drawing data comprises a second set of XML parts.

8. The method of claim 7, further comprising:
decompressing the patent drawing template to obtain the first set of XML parts;
combining the first set of XML parts and the second set of XML parts; and
compressing the combination of the first set of XML parts and the second set of XML parts, wherein the patent drawing document is generated based on the compressed combination.

9. The method of claim 8, further comprising:
identifying one or more figure objects from the application data object; and
generating a page XML part for each of the one or more figure objects, wherein the second set of XML parts comprises the page XML part.

10. The method of claim 1, further comprising:
associating each of the plurality of application features with a system component of the plurality of system components.

11. The method of claim 1, wherein:
the one or more flowchart objects comprise one or more step objects, wherein each of the one or more step objects comprises a text value and a component association.

12. The method of claim 1, wherein:
the one or more diagram objects comprise one or more component objects, wherein each of the one or more component objects comprises a component name and or more application features from the plurality of application features.

13. The method of claim 1, further comprising:
storing the application data object in a database;
retrieving the application data object from the database; and
updating the application data object based on additional input, wherein the specification data is based on the updated application data object.

14. A non-transitory computer readable medium storing code for automated patent preparation, the code comprising instructions executable by a processor to:
identify a patent specification template;
identify an application data object associated with a patent disclosure, wherein the application data object comprises a plurality of application features and a plurality of system components;
generate specification data based on the application data object; and
generate a patent specification document based on the patent specification template and the specification data.

15. The non-transitory computer-readable medium of claim 14, wherein:
the patent specification template comprises a first set of XML parts, and the specification data comprises a second set of XML parts.

16. The non-transitory computer-readable medium of claim 15, the code further comprising instructions executable by a processor to:
decompress the patent specification template to obtain the first set of XML parts;
combine the first set of XML parts and the second set of XML parts; and
compress the combination of the first set of XML parts and the second set of XML parts, wherein the patent specification document is generated based on the compressed combination.

17. The non-transitory computer-readable medium of claim 14, the code further comprising instructions executable by a processor to:
identify a patent drawing template;
generate drawing data based on the application data object; and
generate a patent drawing document based on the patent drawing template and the drawing data.

18. The non-transitory computer-readable medium of claim 14, the code further comprising instructions executable by a processor to:
associate each of the plurality of features with a system component, wherein the application data object is based on the association.

19. An apparatus for automated patent preparation, comprising:
a processor;
memory in electronic communication with the processor; and
instructions stored in the memory and operable, when executed by the processor, to cause the apparatus to:
identify a patent specification template;
identify an application data object associated with a patent disclosure, wherein the application data object comprises a plurality of application features and a plurality of system components;
generate specification data based on the application data object; and
generate a patent specification document based on the patent specification template and the specification data.

20. The apparatus of claim 19, the instructions further operable to cause the apparatus to:
identify a patent drawing template;
generate drawing data based on the application data object; and
generate a patent drawing document based on the patent drawing template and the drawing data.
